(19) United States
(12) Patent Application Publication
(10) Pub. No.: US 2004/0167834 A1
(43) Pub. Date: Aug. 26, 2004

(54) Method for processing accounting requests in a communications system

(76) Inventors: Juha-Pekka Koskinen, Hameenlinna (FI); Juha R. Vallinen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/465,791

(22) Filed: Jun. 20, 2003

Related U.S. Application Data
(60) Provisional application No. 60/446,547, filed on Feb. 12, 2003.

(51) Int. Cl. G06F 17/60

(52) U.S. Cl. 705/30

(57) ABSTRACT

This invention relates to a method for providing accounting requests, where an accounting request comprises at least one identifier and relates to a service provided to a user of a communication network. In the method a first accounting request is transmitted and a second accounting request corresponding to the first accounting request is prepared. The second accounting request comprises at least one of the at least one identifier in the first accounting request as correlation information. The second accounting request is transmitted as a retransmitted first accounting request, if it is determined that retransmission of the first accounting request is required.

### CROSS-REFERENCE TO RELATED APPLICATIONS

This application claims priority of U.S. Provisional Application Ser. No. 60/446,547, entitled “A Method for Processing Accounting Requests in a Communication System and Communication System” filed Feb. 12, 2003, the entire contents of which are incorporated herein by reference.

### BACKGROUND OF THE INVENTION

1. Field of the Invention

The present invention relates to a method for processing accounting requests relating to services provided to a user of a communication network. The present invention relates in particular, but not exclusively, to accounting requests relating to IP multimedia services. The present invention also relates to a communication system and to entities for use in a communication system.

2. Description of the Related Art

A communication system is a facility that enables communication between two or more entities such as user equipment and/or other nodes associated with the system. The communication may comprise, for example, communication of voice, data, multimedia and so on.

Communication systems proving wireless communication for user terminals or other nodes are known. An example of a wireless system is a public land mobile network (PLMN). A PLMN is typically a cellular system wherein a base transceiver station (BTS) or similar access entity serves user equipment (UE) such as mobile stations (MS) via a wireless interface between these entities. The operation of the apparatus required for the communication can be controlled by one or several control entities. The various control entities may be interconnected. One or more gateway nodes may also be provided for connecting the cellular network to other networks, such as to another cellular system or to a public switched telephone network (PSTN) and/or other communication networks such as an IP (Internet Protocol) and/or other packet switched data networks. The communication between the user equipment and the elements of the communication network can be based on an appropriate communication protocol, such as the session initiation protocol (SIP).

A communication system typically operates in accordance with a given standard or specification which sets out what the various elements of the system are permitted to do and how that should be achieved. For example, the standard or specification may define if the user, or more precisely, user equipment or terminal is provided with a circuit switched service and/or a packet switched service. Communication protocols and/or parameters which shall be used for the connection may also be defined. In other words, a specific set of “rules” on which the communication can be based needs to be defined to enable communication by means of the system.

The communication systems typically have separated functions. In addition to provisioning of services for the users of the system the communication system also provides functions such as network management and configuration. In the current third generation (3G) multimedia network architectures various servers are used for handling of provision of different communication services for mobile users. An example of one of the services is the so-called IP multimedia services (IMS), defined in 3^{rd} Generation partnership project 3GPP specifications.

When a server receives a service request from a user, it usually needs to ensure that accounting information is collected for charging the user for the delivered service. With regard to IP Multimedia services which are to be charged online, a server sends an accounting request to an Event Charging Function. When the server receives an accounting answer from the Event Charging Function, the server knows that the subscriber's account has been deducted with an amount corresponding to the service fee. After the receipt of the accounting answer the server can thus deliver the requested service to the user.

It may occur that the server does not receive an accounting answer within a specified time period. This situation may be caused, for example, by one of the following errors. First, the Event Charging Function may have not received the accounting request, which the server sent. Second, the Event Charging Function may have been unable to receive a confirmation from further accounting entities about deducting the subscriber's account. Third, the subscriber's account may have been properly deducted, but either the further accounting entity or the Event Charging Function fails to send an accounting answer. Fourth, the Event Charging Function may have sent the accounting answer properly to the server, but the accounting answer has been lost in the network.

When the server notices that an accounting answer is missing, it retransmits the accounting request in accordance with the specifications. This retransmitted accounting request may be sent to the same Event Charging Function or a different Event Charging Function to that which previously transmitted the accounting request.

According to the 3GPP technical specification TS 32.225 relating to the charging, an accounting request and an accounting answer both contain a session identifier. This session identifier is used to identify the accounting session, to which the accounting messages relate. There may be more than one accounting session, which relate to a given IP multimedia service session. An accounting request also contains, for example, an IMS Charging Identifier for identifying the user account, and an Accounting Record Number for identifying accounting records within an accounting session.

When a retransmitted accounting request is processed in network entities responsible for deducting the user account, there is the need to find out whether a corresponding, previously received accounting request already caused the subscriber's account to be deducted. If the service has already been charged for, it is sufficient to only send the accounting answer to the server. On the other hand, if the service has not yet been charged for, the subscriber's account needs to be deducted before sending the accounting answer.

The specification TS 32.225 discusses in general level detection of duplicate accounting requests. Duplicate detection may be based on inspecting the session identifier values and the accounting record number values.

In general the specifications state that an accounting session identifier must remain the same throughout an accounting session. The specifications remain silent about the value of the accounting session identifier in the case of retransmitted accounting requests. It is thus unclear if a retransmitted accounting request, especially when it is sent to a different Event Charging Function than the earlier corresponding accounting request, begins a new session or continues the earlier session. As the specifications are vague, an application server might change the accounting session identifier or retain the same accounting session identifier for a retransmitted accounting request.

The duplicate detection proposed in the specification, which uses accounting session identifiers and accounting record numbers, may therefore not work. If the accounting session identifier is not the same in an accounting request and in a corresponding retransmitted accounting request, it is not possible to determine whether a previously received accounting request actually relates to the same charging event.

However, the current standardization proposals have not recognized this as a problem. In fact with the current proposals a user could be charged twice for a service, because duplicate accounting requests are not properly detected.

It shall be appreciated that although the above discussed problems relate to IMS in third generation (3G) communication systems, similar disadvantages may be associated with other systems as well and thus the description is not limited to these examples.

### SUMMARY OF THE INVENTION

It is an aim of embodiments of the present invention to address one or more of the problems discussed above.

According to one embodiment of the present invention there is provided a method for providing accounting requests, an accounting request comprising at least one identifier and relating to a service provided to a user of a communication network, the method comprising the steps of:

transmitting a first accounting request,

preparing a second accounting request corresponding to the first accounting request, the second accounting request comprising at least one of the at least one identifier in the first accounting request as correlation information, and

transmitting the second accounting request as a retransmitted first accounting request if it is determined that retransmission of the first accounting request is required.

According to another embodiment of the present invention there is provided a method for processing accounting requests, an accounting request having at least one identifier and relating to a service provided to a user of a communication network, the method comprising the steps of:

receiving an accounting request,

determining if the received accounting request is a retransmitted accounting request having correlation information, the correlation information comprising at least one identifier, and

comparing the correlation information to the at least one of the identifiers in at least one previously received accounting request to determine if the retransmitted accounting request corresponds to a previously received accounting request.

According to a further embodiment of the present invention there is provided an entity for use in a communication network, the entity comprising:

means for transmitting accounting requests, an accounting request comprising at least one identifier,

means for retransmitting accounting requests, a retransmitted accounting request having correlation information, and

means for preparing a retransmitted accounting request having correlation information, said correlation information comprising at least one of the at least one identifiers in a corresponding, previously transmitted accounting request.

According to a further embodiment of the present invention there is provided an entity for use in a communication network, the entity comprising

means for receiving accounting requests, an accounting request comprising at least one identifier,

means for detecting retransmitted accounting request among the received accounting request, a retransmitted accounting request having correlation information comprising at least one the identifiers in a corresponding, previously transmitted accounting request, and

means for comparing a received retransmitted accounting request to at least one previously received accounting request by comparing the correlation information to at least one of the identifiers in at least one previously received accounting request.

According to another embodiment of the present invention there is provided a communication network comprising a first entity and a second entity, the first entity comprising:

means for transmitting accounting requests, an accounting request comprising at least one identifier,

means for retransmitting accounting requests, a retransmitted accounting request having correlation information, and

means for preparing a retransmitted accounting request having correlation information, the correlation information comprising at least one of the at least one identifiers in a corresponding, previously transmitted accounting request,

and the second entity comprising

means for receiving accounting requests,

means for detecting retransmitted accounting request among the received accounting request, a retransmitted accounting request having correlation information comprising at least one the identifiers in a corresponding, previously transmitted accounting request, and

means for comparing a received retransmitted accounting request to at least one previously received accounting request by comparing the correlation information to at least one of the identifiers in at least one previously received accounting request.

Embodiments of the invention are arranged to include correlation information in a retransmitted accounting request. An accounting request may comprise a set of identifiers, which are used to determine to which accounting event the accounting request relates. A retransmitted accounting request preferably comprises, in addition to that set of identifiers, correlation information. This correlation information preferably comprises at least one value of those identifier values, which are present in the previous corresponding accounting request.

Preferably, in those cases, where at least one of the identifier values are different in a retransmitted accounting request and in the corresponding previous accounting request, the correlation information contains those values present in the corresponding previous accounting request. The retransmitted accounting request may thus be properly compared to previously received accounting requests using the correlation information.

In some cases all the values of the identifiers belonging to the identifier set may be same in a retransmitted accounting request and in a corresponding previous accounting request. Even in this case it causes no problems to add, for example, one of the identifier values as correlation information to the retransmitted accounting request. This way the format of all retransmitted accounting requests, which relate to similar charging events, remains the same and processing of the accounting request may be straightforward. In addition, the presence of correlation information may be used to detect that an accounting request is a retransmitted accounting request.

Alternatively, it is possible that the correlation information is present in only to those retransmitted accounting requests, where at least one identifier in the retransmitted accounting request has a value which is different from the values in the first accounting request.

### BRIEF DESCRIPTION OF THE DRAWINGS

For a better understanding of the present invention and as how the same may be carried into effect, reference will now be made by way of example only to the accompanying drawings in which:

FIG. 1 shows one example of a system in which embodiments of the present invention can be implemented;

FIG. 2 shows a message sequence chart according to one embodiment of the invention;

FIG. 3 shows a flowchart of a method of providing an accounting requests in accordance with one embodiment of the first aspect of the invention; and

FIG. 4 shows a flowchart of an accounting request processing method in accordance with one embodiment of the second aspect of the invention.

### DETAILED DESCRIPTION OF PREFERRED EMBODIMENTS

The 3G Partnership Project (3GPP) is defining a reference architecture for the Universal Mobile Telecommunication System (UMTS) core network which will provide the users of user equipment (EU) with access to these services. This Universal Mobile Telecommunication System (UMTS) core network is divided into three principal domains. These are the Circuit Switched domain, the Packet Switched domain and the Internet Protocol Multimedia (IM) domain. The latter of these, the IM domain, makes sure that multimedia services are adequately managed. The IM domain supports the Session Initiation Protocol (SIP) as developed by the Internet Engineering Task Force (IETF).

In the current third generation (3G) multimedia network architectures it is assumed that various servers are used for handling different functions associated with a session. The 3G systems Internet Protocol (IP) multimedia subsystems (IMSs) have been developed in an attempt to conform to Internet standards set out by the IETF (Internet Engineering Task Force) in order to achieve independence of the various access methods and networks, which may be used in accessing the IP multimedia services, and to maintain a smooth interoperation with wireless terminals across the Internet. Therefore, interfaces specified conform as far as possible to IETF standards for those cases where an IETF protocol, e.g. the Session Initiation Protocol (SIP), has been selected.

The IMN enables operators of mobile networks to offer their subscribers multimedia services based on and built upon Internet applications, services, and protocols. The embodiments of the present invention will be described in the context of the UMTS 3G system and session initiation protocol (SIP).

Those interested may gather a more detailed description of the IMN from the 3GPP (3^{rd} Generation Partnership Project) specification TS 23.228.

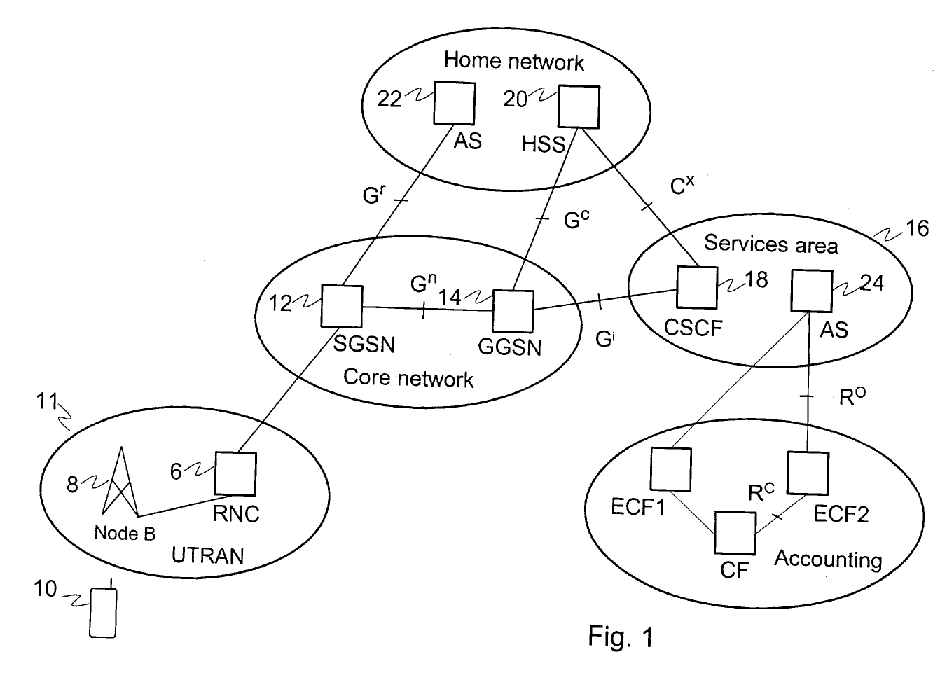

FIG. 1 illustrates a partial internet protocol (IP) multimedia network architecture. A mobile station (MS) 10 can be a mobile telephone or a laptop computer which has a radio modem or a fax adapted for radio access. The term MS is used here as an example of mobile user equipment (UE). This communicates with the Universal Mobile Telecommunication System (UMTS) Radio Access Network (UTRAN) 11 over the radio interface (Uₘ). The UTRAN includes a network element node B 8, which provides equipment for transmission and reception of messages and may additionally include ciphering equipment. This communicates with a radio network controller (RNC) 6 as is known in the art.

The RNC sets up the radio channels for signaling to the core network node 12 which may comprise a serving General Packet Radio Service GPRS support node (SGSN). The signaling occurs over the Iᵤ interface. The SGSN provides the network access node and mobility management functions. The node 12 is a switching node which can perform connection management, mobility management and authentication activities. The core network node 12 is connected to the gateway GPRS support node (GGSN) 14 via the Gₙ interface. The GGSN provides access, via the Gᵢ interface, to the services area 16 over IP packet data networks such as the Internet and Internet service providers (ISP).

The call state control function (CSCF) 18 supports and controls sessions during which the UE obtains IMS services from the services area 16. In addition, CSCF may consist of Proxy, Interrogating and Serving CSCFs as described earlier. The CSCF provides flexibility to modify, add or erase bearers used by the user's services. Amongst other functions the CSCF 18 controls call functions, thus executes call setup, modification and termination and performs address handling. The CSCF accesses the Home Subscriber Server (HSS) 20 via the Cₓ interface. The HSS is a master server containing data relating to a particular user. It contains data relating to a specific user, which can identify how call services are to be carried out and authentication and authorization information. The HSS is located in the home network of the UE user which may be some distance from the location of the UE, which is serviced by a local (visited) network. The HSS is connected to the SGSN and GGSN via the Gᵣ and G_{c} interfaces respectively.

In order to provide access to the Internet and other IM services to users, protocols have been developed to assist in providing telephony services across the Internet. The session initiation protocol (SIP) is one such protocol, which has been developed for controlling the creation, modification and termination of sessions with one or more parties. The call sessions may include Internet or other IP network telephone calls, conferences or other multimedia activities.

In the current third generation (3G) multimedia network architectures various servers are used for handling of provision of different communication services for mobile users. FIG. 1 shows two examples of Application Servers. Application server 22 resides in the home network of a user. Alternatively an application server may reside in any network accessible to the user; Application Server 24 in the service area illustrates this possibility.

With respect to charging for the IP multimedia services, reference is made to TS 32.225 v5.0.0 3rd Generation Partnership Project; Technical Specification Group Service and System Aspects; Telecommunication management; Charging management; Charging data description for the IP Multimedia Subsystem (IMS) (Release 5) which is hereby incorporated by reference.

Charging for services may be either offline or online. In offline charging, charging or accounting information does not affect, in real-time, the service rendered. In online charging, charging or accounting information can affect, in real-time, the service rendered; therefore a direct interaction of the charging mechanism with session/service control is required. In online charging of IP multimedia services, the application server transmits accounting information to an Event Charging Function (ECF). The Event Charging Function forwards the accounting information to a Correlation Function (CF), which resides in an Online Charging System (OCS). FIG. 1 illustrates two Event Charging Functions ECF1 and ECF2, a Correlation Function CF, the R^{o} interface between an application server and an Event Charging Function and the RC interface between an Event Charging Function and a Correlation function.

Two cases for online event charging are distinguished in the specification: Immediate Event Charging (IEC) and Event Charging with Unit Reservation (ECUR). In the case of Immediate Event Charging, a proper amount of monetary units is deducted from the subscriber's account in a single operation. Event Charging with Unit Reservation includes the process of requesting, reserving, releasing and returning unused monetary units. The deduction of the corresponding monetary units then occurs upon conclusion of the ECUR transaction.

An accounting request transmitted by an application server typically indicates, which of these charging mechanisms is to be used for online charging.

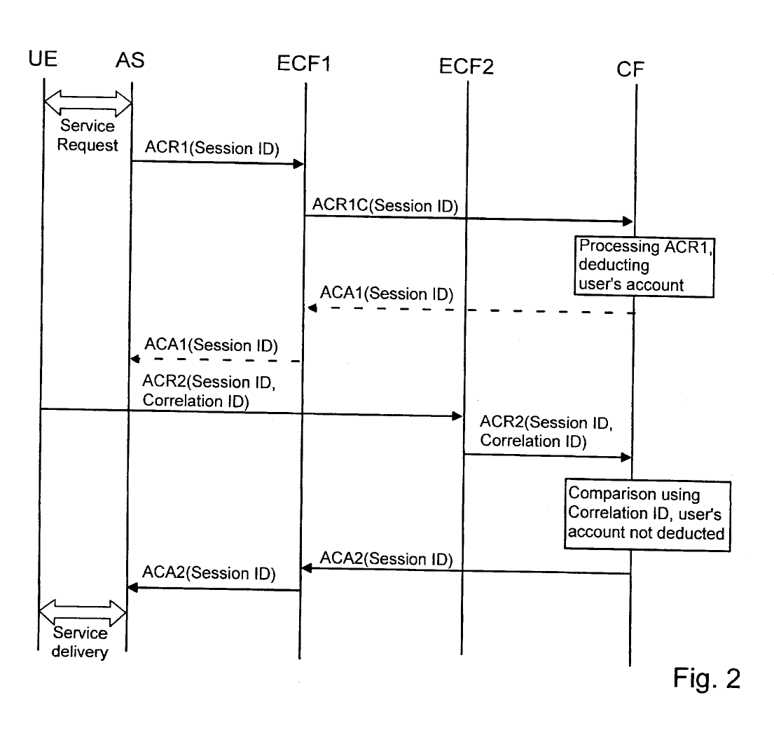

Reference is next made to FIG. 2 which shows a message sequence chart relating to Immediate Event Charging and is in accordance with one embodiment of the invention. The application server (AS) receives first a service request from user equipment (UE); typically this service request is in accordance with the SIP protocol. After receiving a service request, the AS transmits an accounting request ACR1 to Event Charging Function (ECF1). This ACR1 typically includes the following information: accounting session identifier, accounting record number, IMS charging identifier and information specifying online charging mechanisms. In FIG. 2, only accounting session identifier is explicitly shown in connection with ACR1.

If the accounting messages in FIG. 2 are messages according to the TS 32.225 specification and Diameter protocol is used to transmit them, the accounting request ACR1 contains the following Attribute Value Pairs (AVPs): Session-ID, Accounting-Record-Number, IMS-Charging-Identifier, Requested-Action. Table 1 illustrates an example of the contents of the ACR1. When the Diameter protocol is used, the application server acts as a Diameter client. Furthermore, the Session ID is specified in the Diameter protocol.

TABLE 1
Contents of ACR1

| Identifier name | Value |
|---|---|
| Accounting-Session-ID | 12 |
| Accounting-Record-Number | 1 |
| IMS-Charging-Identifier | 23 |
| Requested-Action | DIRECT_DEBITING |

In the situation shown in FIG. 2, the Event Charging Function ECF1 forwards the ACR1 to a Correlation Function (CF). The CF takes care of deducting the subscriber's account properly. Thereafter it sends an accounting answer ACA1 to the ECF1. The ECF1, however, may fail to receive the accounting answer (ACA1). Alternatively, it may fail to forward the ACA1 to the AS or the ACA1 is lost in the network. These options are illustrated in FIG. 2 with dashed arrows. This means that the AS does not receive the accounting answer ACA1 within a predefined time period after transmittance of the ARC1.

As illustrated in FIG. 2, when an accounting answer is not received within the expected time period, the AS retransmits an accounting request to Event Charging Function (ECF2). This retransmitted accounting request (ACR2) contains, in addition to the information contained in the accounting request ACR1, the following information: an accounting correlation identifier and often also further information indicating that ACR2 is a retransmitted accounting request. In FIG. 2 only the session identifier and correlation identifier are illustrated. The value of the correlation identifier in ACR2 is set to be the same as the value of the session identifier in ACR1.

If the accounting messages in FIG. 2 are messages according TS 32.225 specification and Diameter protocol is used to transmit them, the accounting request ACR2 contains the following Attribute Value Pairs (AVPs): Session-ID, Accounting-Record-Number, IMS-Charging-Identifier, Requested-Action, Accounting-Correlation-identifier, and T-flag, which indicates retransmission. The T-flag identifier is a part of the Diameter message header. Table 2 illustrates an example of the contents of the accounting request ACR2.

TABLE 2
Contents of ACR2

| Identifier name | Value |
|---|---|
| Accounting-Session-ID | 13 |
| Accounting-Record-Number | 1 |
| IMS-Charging-Identifier | 23 |
| Requested-Action | DIRECT_DEBITING |
| T-flag | 1 |
| Accounting-correlation-ID | 12 |

As FIG. 2 shows, the AS may send the retransmitted accounting request to a second ECF2. In this case it is possible that the session identifier value in ACR1 is different from the session identifier value in ACR2. But even if the session identifiers are the same in ACR1 and ACR2, it is possible to add the correlation identifier in ACR2. This way the format of a retransmitted ACR is the same irrespective of the values of the other identifiers. Furthermore, in comparing a received retransmitted accounting request in CF it is possible always to compare the correlation identifier value in a received retransmitted accounting request to a session identifier value in an earlier received accounting request.

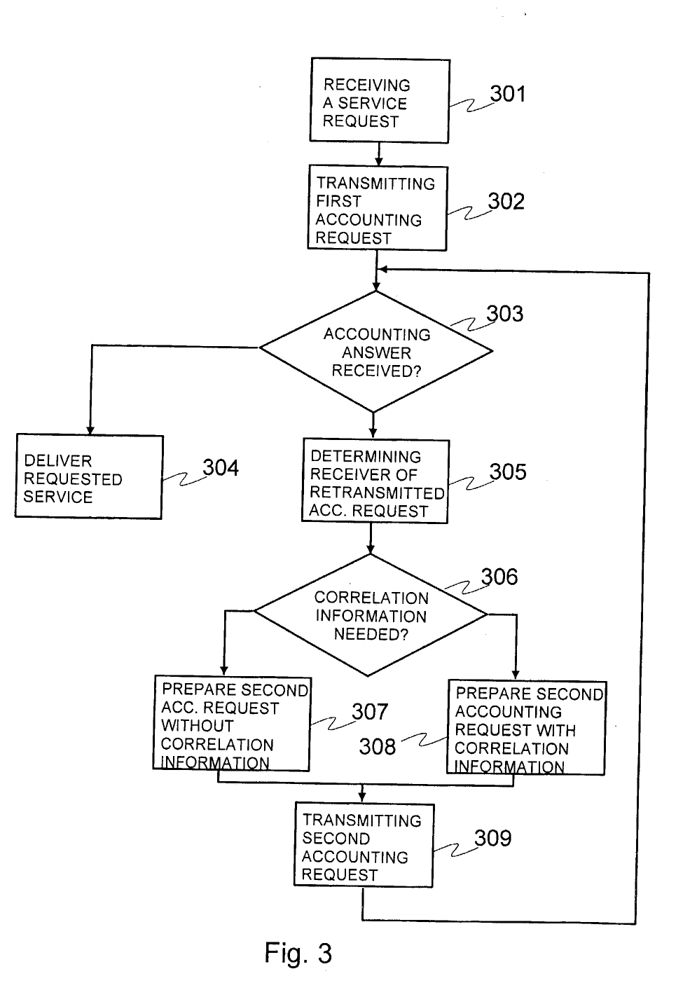

FIG. 3 illustrates a flowchart of a method of providing accounting requests, this method being implemented typically in a server providing services to users in a communication network. In step 301 a service request is received, and in step 302 an accounting request is sent to a Correlation Function or to a network providing similar functionality. The accounting request typically contains information indicating the user to be charged and information for connecting the accounting request to the event causing the accounting request to be sent. In step 303 it is checked whether an accounting answer is received, and if the accounting answer has been received, service is delivered to the user in step 304.

If an accounting answer is not received in step 303, then there may be need to retransmit a second accounting request as a retransmitted first accounting request. In this case, a receiver for the second accounting request is determined in step 305. The receiver may be the same network entity receiving the first accounting request or it may be another network entity. In step 306 it is determined whether correlation information needs to be present in the second accounting request. Then a second accounting request is prepared either with correlation information (step 308) or without correlation information (step 309). Thereafter the second accounting request is transmitted in step 309.

As discussed above, it is possible to have correlation information in all retransmitted accounting requests. In such a case steps 306 and 307 may be discarded.

After transmitting the second accounting request it is again checked in step 303 whether an accounting answer has been received. If not, it is possible to proceed with steps 305-309. It is, however, evident that these steps cannot be continued repeatedly and a method of providing accounting requests should have some error handling routines. These routines are not discussed here, as their details are irrelevant to having correlation information in retransmitted accounting requests.

The Correlation Function detects that the ACR2 is a retransmitted accounting request. This detection may be based on the presence of the correlation identifier or on the presence of some further information indicating retransmission. As the received accounting request ACR2 is a retransmitted one, it is possible that the Correlation Function has already received the corresponding accounting request ACR1. Therefore, there is a need to compare the received retransmitted accounting request to earlier received accounting request. In this comparison, usually only accounting requests received quite recently—within a certain time window—are taken into account. Furthermore, it is advisable to compare the received ACR2 to all received accounting requests, i.e. also to previously received, retransmitted accounting records. This way two or more retransmitted accounting records relating to a certain charging event are noticed, even if the original accounting request never arrived at the Correlation Function.

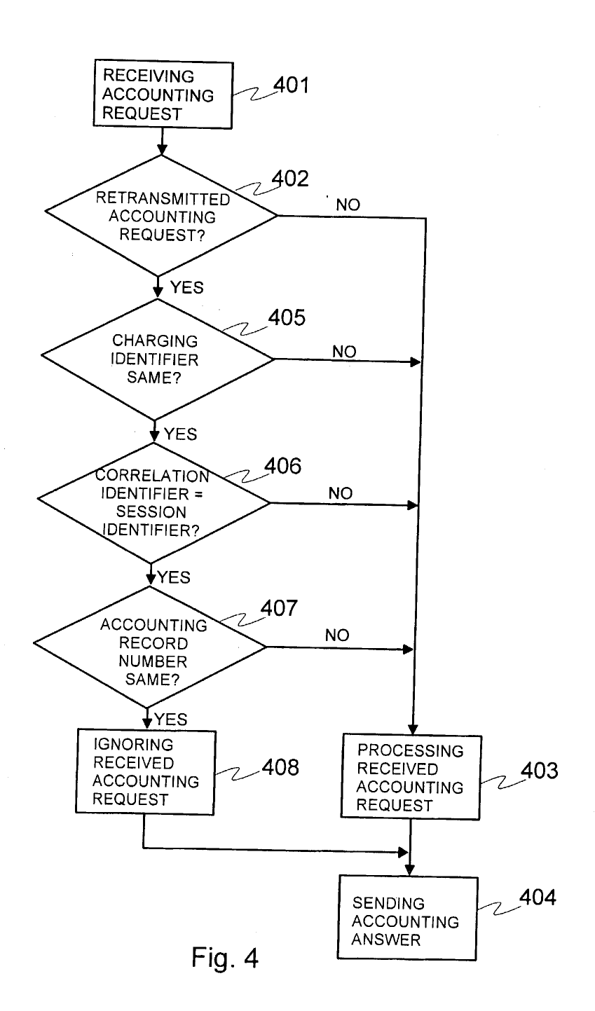

The comparison between previously received accounting requests and the received retransmitted ARC2 uses the correlation identifier value in ACR2 and the session identifier values in previously received accounting requests. If the accounting messages in FIG. 2 are messages according TS 32.225 specification, the comparison is preferably made in the following way, which is illustrated in FIG. 4.

FIG. 4 illustrates the operation in the Correlation Function or in a network entity having similar functionality. In step 401 in FIG. 4 an accounting request is received. In step 402 it is checked whether the received accounting request is a retransmitted accounting request. If the received accounting request is not a retransmitted accounting request, then it is processed in step 403 and an accounting answer is sent in step 404.

If the received accounting request is a retransmitted accounting request, it is compared to previously received accounting requests in steps 405-407. First, the IMS-Charging-Identifier value in the received retransmitted accounting request is compared to IMS-Charging-Identifier values in a previously received accounting request in step 405. If no match is found, there is no earlier accounting request relating to this retransmitted accounting request, and the retransmitted accounting request can be processed in step 403. If at least one previously received accounting request with the same IMS-Charging-Identifier value is found, the correlation identifier value in the received retransmitted accounting request is compared to the accounting session identifier values in those previously received accounting requests in step 406. Again, if no match is found, the received retransmitted accounting request is processed in step 403. If a match is found, the accounting record number value in the received retransmitted accounting request is compared in step 407 to accounting record number values in previously received accounting requests, which were selected in step 406. If a match is not found, the received retransmitted accounting request is processed in step 403. If a match is found, i.e. there is at least one previously received accounting request having the same IMS-Charging-Identifier value and Accounting-record-number value and the session identifier in the previously received accounting request(s) is/are the same as the correlation identifier value in the received retransmitted accounting record, the received retransmitted accounting record is ignored in step 408. This ignoring means that the subscriber account is not deducted. An accounting answer is sent in step 404 to the application server.

Referring again to FIG. 2, after comparing the ACR2 to previously received accounting records, the CF notices that it has already received and processed the corresponding ACR1. Therefore the CF-does not deduct the subscriber's account in the situation illustrated in FIG. 2; it only sends ACA2 to the ECF1, which in turn forwards this ACA2 to the AS. The AS then delivers the request service to UE.

If, in contrast to the situation illustrated in FIG. 2, the CF had not received the ARC1, it would process the received retransmitted ACR2 and cause the subscriber's account to be deducted. Only thereafter the CF would send the ACA2.

Above reference is made to Diameter protocol; see Diameter Base Protocol document for details of this protocol. The most recent version of the Diameter Base Protocol document at the time of filing this application is found at link http://www.ietf.org/internet-drafts/ under name draft-ietf-aaa-diameter-17.txt. As an alternative to the Diameter protocol, it is possible to transmit accounting messages using the Radius protocol; see Remote Authentication Dial In User Service (RADIUS), RFC 2865, http://www.ietf.org/rfc/rfc2865.txt for details of this protocol. Either of these protocols may be used in transmitting also accounting messages in accordance with other specifications than 3GPP TS 32.225.

In this description and claims messages relating to accounting have been called accounting requests and accounting answers. These names are descriptive, and the intention is to cover any messages relating to accounting and used similarly as accounting requests and answers described above, irrespective of the name of those messages.

Although the detailed description of the present invention relates to online charging and in more particular to immediate event charging, the invention is applicable also more generally to online charging and offline charging. In offline charging the service delivery is usually not dependent on the receipt of an accounting answer, so an accounting entity need not necessary send an accounting answer in connection with comparing a retransmitted accounting request to previous received accounting requests.

Furthermore, the accounting event relating to the accounting request may be a refund, not only a fee to be charged from a subscriber.

Although the invention has been described by referring to the IP Multimedia Services architecture and 3G communication systems, this invention is also applicable to any other communication systems and protocols, where similar accounting messages are used. Examples of other systems, without limiting to these, include the public internet and cable networks.

Diameter and Radius protocols are mentioned only as examples of protocols, in accordance with which the accounting messages may be.

It should be appreciated that whilst embodiments of the present invention have been described in relation to user equipment such as mobile stations, embodiments of the present invention are applicable to any other suitable type of users. Various user equipment (UE) such as computers (fixed or portable), mobile telephones, personal data assistants or organizers and so on are known to the skilled person and can be used to access the internet to obtain services or to establish a session.

1. Method for providing accounting requests, an accounting request comprising at least one identifier and relating to a service provided to a user of a communication network, the method comprising the steps of:
transmitting a first accounting request,
preparing a second accounting request corresponding to the first accounting request, said second accounting request comprising at least one identifier in the first accounting request as correlation information, and
transmitting the second accounting request as a retransmitted first accounting request if a determination is made that retransmission of said first accounting request is required.

2. A method as defined in claim 1, wherein the second accounting request is transmitted, if an acknowledgement of a receipt of the first accounting request is not received within a redefined time period.

3. A method as defined in claim 1, wherein the first accounting request is transmitted to a first entity and the second accounting request is transmitted to a second entity.

4. A method as defined in claim 1, wherein a first identifier of the at least one identifier in the first- accounting request is different from said first identifier present in the second accounting request and said correlation information comprises the first identifier in the first accounting request.

5. A method as defined in claim 4, wherein the correlation information is a correlation identifier, the method comprising a further step of:
setting the correlation identifier to be equal to said first identifier in the first accounting request.

6. A method as defined in claim 5, wherein said first identifier is a session identifier.

7. A method as defined in claim 6, wherein an accounting request comprises an accounting record number, the method further comprising the step of:
setting the accounting record number in the second accounting request to equal the accounting record number in the first accounting request.

8. A method as defined in claim 4, wherein at least a second identifier of the at least one identifier in the first accounting request is different from at least a second identifier present in the second accounting request and said correlation information further comprises said at least second identifier in the first accounting request.

9. A method as defined in claim 1, wherein said second accounting request comprises, in addition to the correlation information, at least one identical identifier as in the first accounting request.

10. A method as defined in claim 9, wherein at least one value of the at least one identical identifier in said first and second accounting requests are different.

11. A method as defined in claim 1, further comprising the steps of:
receiving the second accounting request,
detecting that the received second accounting request is to be a retransmitted accounting request comprising correlation information, and
comparing said correlation information to said at least one the identifiers in at least one previously received accounting request to determine if the received retransmitted accounting request corresponds to a previously received accounting request.

12. A method as defined in claim 11, further comprising the following step of:
ignoring the received second accounting request, if a corresponding previously received accounting request is found.

13. A method as defined in claim 11, further comprising the following step of:
processing the received second accounting request to cause a charging event at a user account, if a corresponding previously received accounting request is not found.

14. A method as defined in claim 11, further comprising the step of:
sending an acknowledgment of the receipt of the received second accounting request.

15. A method as defined in claim 11, wherein a first identifier of the at least one identifier in the first accounting request is different from said first identifier present in the second accounting request and the correlation information is a correlation identifier, the step of comparing comprising:
comparing the correlation identifier to said first identifier in at least one previously received accounting request.

16. A method as defined in claim 15, wherein said first identifier is a session identifier.

17. A method as defined in claim 16, wherein an accounting request comprises further an accounting record number, the step of comparing comprising:
comparing the correlation identifier in the received second accounting request to a session identifier in at least one previously received accounting request, and
comparing the accounting record number in the received second accounting request to an accounting record number in at least one previously received accounting request.

18. A method as defined in claim 17, wherein an accounting request further comprises a charging identifier, the step of comparing further comprising:
comparing, before comparing the correlation identifier and the accounting record number in the received second accounting request, the charging identifier in the received second accounting request to a charging identifier in at least one previously received accounting request.

19. A method as defined in claim 1, wherein an accounting request is an Accounting Request of the IP Multimedia Subsystem charging architecture.

20. A method as defined in claim 1, wherein accounting requests are transmitted using Diameter protocol, an accounting request comprises a Diameter session identifier, and a retransmitted accounting request comprises information indicating retransmission.

21. A method as defined in claim 1, wherein accounting requests are transmitting using Radius protocol.

22. A method as defined in claim 1, wherein a plurality of identifiers are arranged to have a plurality of different values, said plurality of different values providing respective information for respective identifiers.

23. A method as defined in claim 22, wherein the correlation information is a correlation identifier.

24. A method as defined in claim 1, wherein the at least one identifier comprises first information indicating the name of the at least one identifier and second information indicating the value of the at least one identifier.

25. A method as defined in claim 24, wherein the at least one identifier is transmitted as an Attribute Value Pair.

26. A method as defined in claim 24, wherein the correlation information is a correlation identifier.

27. A method as defined in claim 1, wherein the retransmitted accounting request relates to a one-time charging event.

28. A method as defined in claim 27, wherein the one-time charging event is an event to be charged from a subscriber account.

29. A method as defined in claim 27, wherein the one-time charging event is an event to be refunded to a subscriber account.

30. A method as defined in claim 1, wherein the first accounting request relates to online charging.

31. A method as defined in claim 1, wherein the first accounting request relates to offline charging.

32. A method for processing accounting requests, an accounting request having at least one identifier and relating to a service provided to a user of a communication network, the method comprising the steps of:
receiving an accounting request,
determining if the received accounting request is a retransmitted accounting request having correlation information, said correlation information comprising at least one identifier, and
comparing the correlation information to at least one identifier in at least one previously received accounting request to determine if the retransmitted accounting request corresponds to a previously received accounting request.

33. A method as defined in claim 32, further comprising the step of:
sending an acknowledgment of receipt of the received retransmitted accounting request, if the received accounting request is a retransmitted accounting request.

34. A method as defined in claim 32, further comprising the step of:
ignoring the received retransmitted accounting request, if a corresponding previously received accounting request is found.

35. A method as defined in claim 32, further comprising the step of:
processing the received retransmitted accounting request for causing a charging event at a user account, if a corresponding previously received accounting request is not found.

36. A method as defined in claim 32, wherein an accounting request is an Accounting Request of the IP Multimedia Subsystem charging architecture.

37. A method as defined in claim 32, wherein accounting requests are transmitted using Diameter protocol, an accounting request comprises a Diameter session identifier, and the retransmitted accounting request comprises information indicating retransmission.

38. A method as defined in claim 32, wherein accounting requests are transmitted using Radius protocol.

39. A method as defined in claim 32, wherein a plurality of identifiers are arranged to have a plurality of different values, said plurality of different values providing respective information for the respective identifiers.

40. A method as defined in claim 39, wherein the correlation information is a correlation identifier.

41. A method as defined in claim 32, wherein the at least one identifier comprises first information indicating the name of the at least one identifier and second information indicating the value of the at least one identifier.

42. A method as defined in claim 41, wherein the at least one identifier is transmitted as an Attribute Value Pair.

43. A method as defined in claim 41, wherein the correlation information is a correlation identifier.

44. A method as defined in claim 32, wherein the retransmitted accounting request relates to a one-time charging event.

45. A method as defined in claim 44, wherein the one-time charging event is an event to be charged from a subscriber account.

46. A method as defined in claim 44, wherein the one-time charging event is an event to be refunded to a subscriber account.

47. A method as defined in claim 32, wherein the retransmitted accounting request relates to online charging.

48. A method as defined in claim 32, wherein the first accounting request relates to offline charging.

49. An entity for use in a communication network, the entity comprising:
means for transmitting accounting requests, an accounting request comprising at least one identifier,
means for retransmitting accounting requests, a retransmitted accounting request having correlation information, and
means for preparing a retransmitted accounting request having correlation information, said correlation information comprising at least one identifier in a corresponding, previously transmitted accounting request.

50. An entity as defined in claim 49, wherein the entity is configured to transmit a accounting request to a separate entity in the communication network and a corresponding retransmitted accounting request to a further separate entity in the communication network.

51. An entity as defined in claim 49, wherein said at least one identifier comprises a session identifier, the entity is configured to use a different session identifier value in a retransmitted accounting request than in a corresponding previously transmitted accounting request, and the correlation information comprises the session identifier in the corresponding previously transmitted accounting request.

52. An entity as defined in claim 49, the entity being an Application Server of the IP Multimedia Subsystem.

53. An entity for use in a communication network, the entity comprising
means for receiving accounting requests, an accounting request comprising at least one identifier,
means for detecting retransmitted accounting request among the received accounting request, a retransmitted accounting request having correlation information comprising at least one the identifiers in a corresponding, previously transmitted accounting request, and
means for comparing a received retransmitted accounting request to at least one previously received accounting request by comparing the correlation information to at least one of the identifiers in at least one previously received accounting request.

54. An entity as defined in claim 53, the entity being configured to provide Correlation Function of the IP Multimedia Subsystem Charging.

55. A communication network comprising a first entity and a second entity, the first entity comprising:
means for transmitting accounting requests, an accounting request comprising at least one identifier,
means for retransmitting accounting requests, a retransmitted accounting request having correlation information, and
means for preparing a retransmitted accounting request having correlation information, said correlation information comprising the at least one identifier in a corresponding, previously transmitted accounting request, and the second entity comprising
means for receiving accounting requests,
means for detecting retransmitted accounting request among the received accounting request, a retransmitted accounting request having correlation information comprising the at least one identifier in a corresponding, previously transmitted accounting request, and
means for comparing a received retransmitted accounting request to at least one previously received accounting request by comparing the correlation information to at least one identifier in at least one previously received accounting request.

56. A communication network as defined in claim 55, wherein the first entity is an Application Server of the IP Multimedia Subsystem and the second entity is configured to provide Correlation Function of the IP Multimedia Subsystem Charging.

57. A communication network as defined in claim 55, further comprising a third entity and a fourth entity, each of the third and fourth entity having
means for receiving accounting request, and
means for forwarding the received accounting request to the second entity,
wherein the first entity is being arranged to transmit an accounting request to the third entity and a corresponding retransmitted accounting request to the fourth entity.

58. A communication network as defined in claim 57, wherein the third entity and the fourth entity are arranged to provide an Event Charging Function of the IP Multimedia Subsystem Charging.
